(19) United States
(12) Patent Application Publication
(10) Pub. No.: US 2022/0324562 A1
(43) Pub. Date: Oct. 13, 2022

(54) MUM-T ASSET HANDOFF

(71) Applicant: Rockwell Collins, Inc., Cedar Rapids, IA (US)

(72) Inventors: James Kleveland, Marion, IA (US); Korey Breger, Coralville, IA (US)

(21) Appl. No.: 17/229,456

(22) Filed: Apr. 13, 2021

(51) Int. Cl. B64C 39/02; G06F 3/04817; G06F 3/04886

(52) U.S. Cl. CPC B64C 39/024; B64C 39/022; G06F 3/04817; G06F 3/04886; B64C 2201/146

(57) ABSTRACT

A computer apparatus includes a touchscreen display. The computer apparatus generates a graphical user interface on the touchscreen display and receive user inputs via the touchscreen display. The graphical user interface includes symbology representing multiple unmanned teamed assets, a primary command and control asset currently controlling the unmanned teamed assets, and one or more secondary command and control assets not currently controlling the unmanned teamed asset. By the touchscreen display, an operator selects one of the secondary command and control assets for transferring control. The computer apparatus may be coupled with either the primary or the secondary command and control asset. The computer apparatus may initiate the transfer request. Similarly, the computer apparatus may receive the transfer request and confirm transfer.

### GOVERNMENT LICENSE RIGHTS

This invention was made with government support under Contract Number 20180628YLC1 awarded by the Department of Defense. The government has certain rights in the invention.

### BACKGROUND

A factor contributing to the complexity of current and future battlespaces is manned unmanned teaming (MUM-T) operations. MUM-T operations describe a scenario in which a human operator (e.g., in an airborne platform or a platform on the ground) is controlling one or more unmanned platforms (e.g., unmanned vehicles). During manned unmanned teaming (MUM-T) aircraft operations there needs to be a mechanism for transferring command and control authority over the unmanned vehicles as they transition from launch to the mission area, and similarly for recovery. Therefore, it would be advantageous to provide a device, system, or method that cures the shortcomings described above.

### SUMMARY

A computer apparatus is described in accordance with one or more embodiments of the present disclosure. In one embodiment, the computer apparatus includes at least one processor. In another embodiment, the computer apparatus includes a communication interface coupled with the processor. In another embodiment, the communication interface is configured to couple with a primary command and control asset which is in control of unmanned teamed assets. In another embodiment, the communication interface is configured to receive information regarding a plurality of unmanned teamed assets from the primary command and control asset and transmit the information to the at least one processor. In another embodiment, the computer apparatus includes a touchscreen display in communication with the processor. In another embodiment, the computer apparatus includes a memory in communication with the processor. In another embodiment, the memory stores processor executable code for configuring the at least one processor. In another embodiment, the at least one processor is configured, by the processor executable code, to generate a graphical user interface for the touchscreen display. In another embodiment, the graphical user interface includes symbology associated with each of the plurality of unmanned teamed assets based on the information received from the primary command and control asset. In another embodiment, the graphical user interface includes symbology associated with the primary command and control asset and at least one secondary command and control asset. In another embodiment, the at least one processor is configured, by the processor executable code, to receive, by the touchscreen display, a user input of an asset transfer request of the unmanned teamed assets from the primary command and control asset to the secondary command and control asset. In another embodiment, the at least one processor is configured, by the processor executable code, to communicate, by the communication interface, the asset transfer request to the primary command and control asset. In another embodiment, the at least one processor is configured, by the processor executable code, to receive, by the communication interface, an asset transfer confirmation from the primary command and control asset. In another embodiment, the at least one processor is configured, by the processor executable code, to update the graphical user interface to indicate the asset transfer confirmation.

A computer apparatus is described in accordance with one or more embodiments of the present disclosure. In one embodiment, the computer apparatus includes at least one processor. In another embodiment, the computer apparatus includes a communication interface coupled with the processor. In another embodiment, the communication interface is configured to couple with a secondary command and control asset which is not currently in control of unmanned teamed assets. In another embodiment, the communication interface is configured to receive information regarding a plurality of unmanned teamed assets from the secondary command and control asset and transmit the information to the at least one processor. In another embodiment, the computer apparatus includes a touchscreen display in communication with the processor. In another embodiment, the computer apparatus includes a memory in communication with the processor. In another embodiment, the memory stores processor executable code for configuring the at least one processor. In another embodiment, the at least one processor is configured, by the processor executable code, to generate a graphical user interface for the touchscreen display. In another embodiment, the graphical user interface includes symbology associated with each of the plurality of unmanned teamed assets based on the information received from the secondary command and control asset. In another embodiment, the graphical user interface includes symbology associated with the secondary command and control asset and a primary command and control asset currently in control of the unmanned teamed assets. In another embodiment, the at least one processor is configured, by the processor executable code, to receive, by the communication interface, an asset transfer request from the secondary command and control asset. In another embodiment, the at least one processor is configured, by the processor executable code, generate an asset transfer confirmation dialog on the touchscreen display. In another embodiment, the at least one processor is configured, by the processor executable code, receive, by the touchscreen display, a user input confirming a transfer of control of the unmanned teamed assets from the primary command and control asset to the secondary command and control asset. In another embodiment, the at least one processor is configured, by the processor executable code, to communicate, by the communication interface, the user input to the secondary command and control asset. In another embodiment, the at least one processor is configured, by the processor executable code, to receive, by the communication interface, an asset transfer confirmation from the secondary command and control asset. In another embodiment, the at least one processor is configured, by the processor executable code, to update the graphical user interface to indicate the asset transfer confirmation.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 depicts a schematic diagram of a computer apparatus, in accordance with one or more embodiments of the present disclosure.

FIGS. 2A-2B depicts a graphical user interface of a display, in accordance with one or more embodiments of the present disclosure.

FIG. 3 depicts a graphical user interface of a display, in accordance with one or more embodiments of the present disclosure.

FIG. 4 depicts a graphical user interface of a display, in accordance with one or more embodiments of the present disclosure.

FIGS. 5A-5B depicts a graphical user interface of a display, in accordance with one or more embodiments of the present disclosure.

### DETAILED DESCRIPTION OF THE INVENTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise. Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Broadly, embodiments of the present disclosure are directed to a computer apparatus. The computer apparatus enables handoffs of unmanned teamed assets between command and control assets. The computer apparatus may be configured to initiate an asset transfer requests between the command-and-control assets. The computer apparatus may transfer the asset transfer request to a command and control asset to which the computer apparatus is coupled. For example, the computer apparatus may be coupled with a command and control asset which is currently controlling the unmanned teamed assets (e.g., a primary command and control asset) or may be coupled with a command and control asset which may control, but which is not currently controlling, the unmanned teamed assets (e.g., a secondary command and control asset). The computer apparatus may also be configured to facilitate asset transfer requests which are not initiated by the computer apparatus. For example, the computer apparatus may receive a transfer request and generate an asset transfer confirmation dialog. In embodiments, the computer apparatus is configured to both initiate asset transfer requests and facilitate asset transfer requests which are not initiated by the computer apparatus.

An asset may refer to vehicles (manned vehicles and/or unmanned vehicles), such as, but not limited to, aircraft (e.g., manned aircraft and/or unmanned aerial systems (UAS)), spacecraft, ground vehicles, ships, soldiers, military installations, and the like. Likewise, teamed assets may refer to friendly assets. Thus, an unmanned teamed asset may refer to a vehicle (e.g., the UAS) which includes no human crew physically present, which is also a friendly asset. In embodiments, the unmanned teamed asset may include any unmanned aerial system known in the art or any future unmanned aerial system. The unmanned teamed assets may generally be controlled by a command and control (C2) asset.

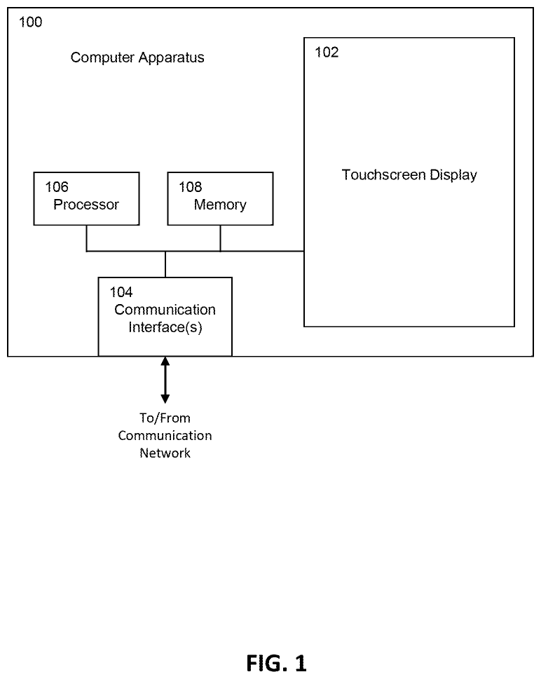

Referring to FIG. 1, a computer apparatus 100 is described, in accordance with one or more embodiments of the present disclosure. By the computer apparatus 100, an operator may be provided with an intuitive interface to manage MUM-T handoffs. The computer apparatus 100 may be part of a handheld electronic device, such as a tablet computer (e.g., iOS, Android, Windows, and Linux based tablets, Apple iPad, etc.), and may be coupled (e.g., wired or wirelessly) to various electronics of an aircraft or other command and control asset. Alternatively, the computer apparatus 100 may be integrated into an aircraft control center as one or more of a primary flight display (PFD), a multi-function display (MFD), or a heads-up display.

The computer apparatus 100 may include the touchscreen display 102, a communication interface 104, a processor 106, and a memory 108. One or more of the touchscreen display 102, the communication interface 104, the processor 106, and the memory 108 may be communicatively coupled by a control bus. For example, the communication interface 104 may be coupled with the processor 106 for transmitting and receiving various information or signals.

The touchscreen display 102 may provide an operator a means for facilitating handoff of one or more unmanned teamed assets. For example, the touchscreen display 102 may be configured to display a user interface including various symbology associated with multiple unmanned teamed assets to an operator. The touchscreen display 102 may include a touch sensitive surface which is configured to receive an input from the operator. Thus, the touchscreen display 102 may allow an operator to interact with the computer apparatus 100, including through the execution of stored procedures. The touchscreen display 102 may include a monochrome display or a color display for displaying the symbology.

The communication interface 104 may be coupled with a command and control asset. The command and control asset may include a primary unmanned teamed asset currently in control of unmanned teamed assets. Alternatively, the command and control asset may include a secondary command and control asset not currently in control of the unmanned teamed assets. By the coupling, the computer apparatus 100 may be in communication with various avionics systems (e.g., flight management systems, aircraft controller, a communication network, etc.) to receive and/or transmit information associated with one or more unmanned teamed assets. The communication interface 104 may include any suitable interface for interfacing with the unmanned teamed asset, such as, but not limited to, a wired or a wireless network interface. The communication interface 104 may include mechanical, electrical, or signaling circuitry for communicating information to and from an aircraft communication network (e.g., Common Avionics Architecture System (CAAS)) and subsequently to various other sensors, components, and aircraft systems. The various aircraft systems may further communicate with distant aircraft system via a suitable communication link, such as, but not limited to, a Link 16 standard. For example, the aircraft communication network may further communicate with an aircraft communication network of one or more additional unmanned teamed assets to which the computer apparatus 100 is not coupled. In embodiments, the communication interface 104 may also be configured store and retrieve such information in the memory 108. For example, the communication interface 104 may be communicatively coupled with the processor 106 and/or the memory 108 for storing and retrieving information from the memory 108.

The processor 106 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the processor 106 may include any device configured to execute algorithms and/or instructions (e.g., program instructions stored in memory 108). Further, the steps described throughout the present disclosure may be carried out by a single processor 106 or, alternatively, multiple processors 106.

The memory 108 may include any storage medium known in the art suitable for storing program instructions or code executable by the processor 106. For example, the memory 108 may include a non-transitory memory medium. By way of another example, the memory 108 may include, but is not limited to, a read-only memory (ROM), a random-access memory (RAM), a magnetic or optical memory device (e.g., disk), a magnetic tape, a solid-state drive and the like. It is further noted that memory 108 may be housed in a common controller housing with the processor 106.

The processor 106 may be configured based on the program instructions maintained on the memory 108. By the program instructions, the computer apparatus 100 may initiate an asset transfer request. For example, the program instructions may cause the processor 106 to generate a graphical user interface for the touchscreen display 102, receive a user input from the touchscreen display 102 requesting an asset transfer request (e.g., transfer control) of the unmanned teamed assets, communicate the asset transfer request, receive an asset transfer confirmation, and update the graphical user interface to indicate the asset transfer confirmation. By the program instructions, the computer apparatus 100 may also receive an asset transfer request which is not initiated by the computer apparatus 100 (e.g., the asset transfer request may originate from a different command and control asset, or an additional computer apparatus 100 coupled with the different command and control asset). For example, the program instructions may cause the processor 106 to receive an asset transfer request, generate an asset transfer confirmation dialog on the touchscreen display 102, receive a user input confirming or denying the asset transfer from the touchscreen display, and communicate the asset transfer confirmation by the communication interface 104.

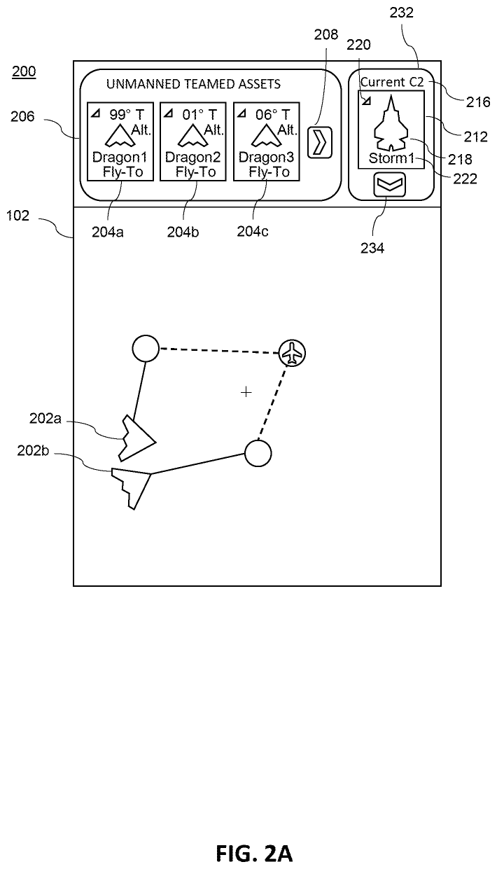

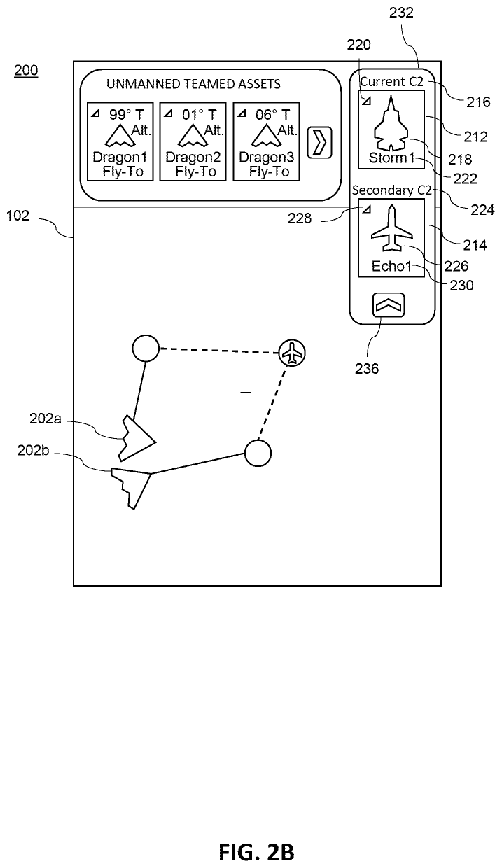

Referring now to FIGS. 2A-2B, a graphical user interface 200 displayed by the touchscreen display 102 is described, in accordance with one or more embodiments of the present disclosure.

In embodiments, the graphical user interface 200 includes various symbology generated by the processor 106. The processor 106 may be configured to receive information (e.g., position and orientation information) regarding unmanned teamed assets. Based on the information, the processor 106 may be configured to generate symbology (e.g., map symbology including a UAV symbol 202 (e.g., UAV symbols 202a, 202b) indicative of the current position and orientation information) associated with the plurality of unmanned teamed assets. As may be understood, the symbology may further include various flight path and/or waypoints associated with the unmanned teamed assets, as appropriate. The symbology associated with the unmanned teamed assets may further unmanned teamed asset cards 204 (e.g., unmanned teamed asset cards 204a, 204b, 204c). The unmanned teamed asset cards 204 may include various information associated with the unmanned teamed assets, such as, but not limited to, a connection indicator, a type of the unmanned teamed asset, a call sign, an objective, a bearing indicator, or an altitude. The unmanned teamed asset cards 204 may be displayed in a panel 206, the panel 206 being disposed along any suitable portion of the touchscreen display 102, such as, but not limited to, a top portion. Depending on a number of unmanned teamed assets in the MUM-T operation and a size of the unmanned teamed asset cards 204, only a portion of the unmanned teamed asset cards 204 may be concurrently displayed in the panel 206. To view additional unmanned teamed assets, the panel 206 may include a scroll bar 208, or other suitable user interface control. For example, if there are more than three unmanned teamed assets as depicted, the panel may be scrolled by a swipe gesture.

The processor 106 may also be configured to display symbology associated with a primary command and control asset (i.e., a command and control asset currently in control of the unmanned teamed assets) and one or more secondary command and control assets (i.e., a command and control asset which is not currently in control of the unmanned teamed assets). For example, the symbology may include a primary card 212 (e.g., an icon) associated with the primary command and control asset and one or more secondary cards 214, each associated with one of the secondary command and control assets. The primary card 212 may include, but is not limited to an indicator 216 (e.g., “Current QB”, “Current C2”, “Primary C2”, etc.), a symbol 218 representing a type of the primary command and control asset (e.g., a fighter symbol, an Airborne Warning And Control System (AWACS) symbol, etc.), a connection indicator 220, and a call sign 222. Similar to the primary icon, the secondary card(s) may include an indicator 224 (e.g., “Secondary QB”, “Secondary C2”, etc.), a symbol 226 representing a type of the secondary command and control asset, a connection indicator 228, and a call sign 230. In embodiments, the primary card 212 and the secondary card 214 may be included in a panel 232. The panel 232 may be disposed along any suitable portion of the touchscreen display 102, such as, but not limited to, a top portion. For example, the panel 232 may be disposed adjacent to the panel 206.

In embodiments, the symbology associated with the secondary command and control asset (e.g., the secondary card 214) may be displayed in response to receiving a user input requesting a display of the secondary command and control asset. To save space on the touchscreen display 102, the secondary card 214 may be hidden until requested. For example, the panel 232 may include a drop-down arrow 234 or any other suitable graphical user interface control. By the drop-down arrow 234, the secondary card 214 may remain hidden until requested (see FIG. 2A). The panel 232 may then be collapsed by a drop-up arrow 236 (see FIG. 2B).

The touchscreen display 102 is not intended to be limited by the symbology depicted. Furthermore, the touchscreen display 102 may additionally display various other symbology on the graphical user interface, such as an area of land or sea showing physical features (e.g., lakes, rivers, ground topology), cities, or roads. In embodiments, the panel 206 and the panel 232 may each include an outline with a color. The panel 206 and the panel 232 may each include different colors, such as, but not limited to, a blue color and a white color.

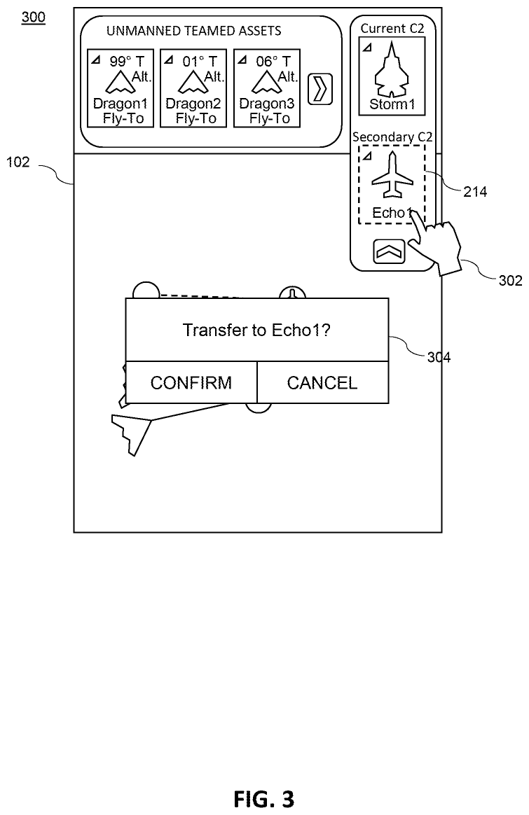

Referring now to FIG. 3, a graphical user interface 300 displayed by the touchscreen display 102 is described, in accordance with one or more embodiments of the present disclosure. The touchscreen display 102 may be configured to receive a user input 302. The user input 302 may include a selection of the secondary card 214. The processor 106 may be configured to receive the user input 302 from the touchscreen display 102. Upon receiving the user input 302, the processor may optionally generate a confirmation message 304 on the touchscreen display. The confirmation message 304 may include one or more buttons (e.g., confirm, cancel, etc.). Where the computer apparatus 100 is coupled to the primary command and control asset, the confirmation message 304 may include a dialog box indicating whether to transfer to the selected secondary command and control asset (e.g., Transfer to Echo1). Where the computer apparatus 100 is coupled to the secondary command and control asset the confirmation message 304 may similarly include a dialog box indicating whether to transfer from the primary command and control asset (e.g., Transfer from Storm1).

The processor 106 may further be configured to adjust the primary card 212 and the secondary card 214 in response to the asset transfer request. The adjustment may include, but is not limited to, adjusting a background color or a line type surrounding the primary card 212 or the secondary card 214. For example, a background color of the primary card 212 may greyed out and the secondary card 214 may be surrounded by a dashed line.

The processor 106 may then transfer the asset transfer request to an unmanned teamed asset to which the computer apparatus 100 is coupled. For example, the computer apparatus 100 may be coupled to the primary command and control asset. The computer apparatus 100 may transfer the asset transfer request to the primary command and control asset by the communication interface 104. The primary command and control asset may then transfer the asset transfer request to the secondary command and control asset by any suitable transfer protocol (e.g., by a link 16 protocol). By way of another example, the computer apparatus 100 may be coupled to the secondary command and control asset. The computer apparatus 100 may transfer the asset transfer request to the secondary command and control asset by the communication interface 104. The secondary command and control asset may then transfer the asset transfer request to the primary command and control asset by any suitable protocol.

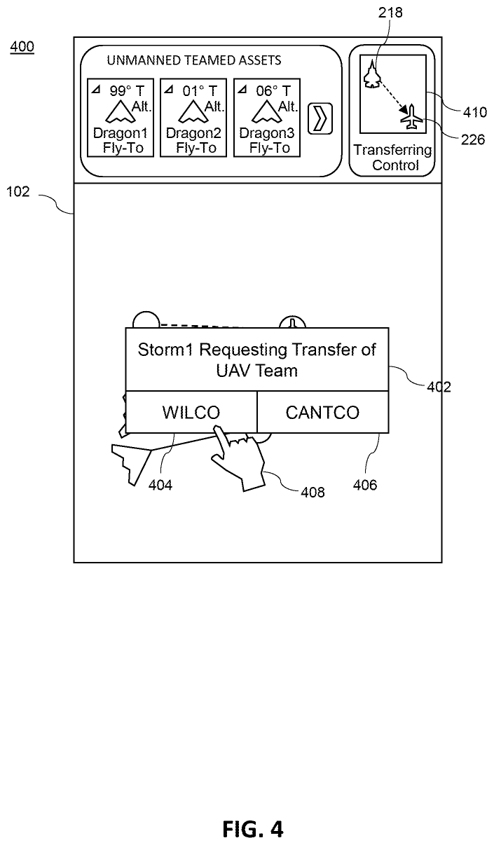

Referring now to FIG. 4 a graphical user interface 400 displayed by the touchscreen display 102 is described, in accordance with one or more embodiments of the present disclosure.

The computer apparatus 100 may be configured to receive, by the communication interface, an asset transfer request from the command and control asset to which the computer apparatus 100 is coupled. For example, a separate computer apparatus may originate the asset transfer request. The asset transfer request may be then be transferred to the computer apparatus 100 (e.g., via the primary or secondary command and control assets). In response to receiving the asset transfer request, the processor 106 may generate an asset transfer confirmation dialog 402 on the touchscreen display 102. The asset transfer confirmation dialog 402 may include an indication of which command and control asset is requesting the transfer. For example, Storm1 may be the primary command and control asset. Storm1 may originate a transfer request of the unmanned teamed assets to Echo1. The computer apparatus 100 may be coupled with Echo1. Echo1 may transmit the asset transfer request to the computer apparatus 100, and the processor 106 may generate the asset transfer dialog 402 (e.g., Storm1 Requesting Transfer of UAV Team). By way of another example, the asset transfer request may originate from the secondary command and control asset and the processor 106 may generate an asset transfer dialog (e.g., Echo1 Requesting Transfer of UAV Team).

The asset transfer confirmation dialog may further include one or more user input response boxes 404, 406 (e.g., can't comply and will comply, etc.). The processor 106 may then be configured to receive, by the touchscreen display 102, a user input 408 confirming a transfer of control of the unmanned teamed assets from the primary command and control asset to the secondary command and control asset (e.g., by selecting the user input response box 404). The processor 106 may then communicate, by the communication interface 104, the asset transfer confirmation to the command and control asset to which the computer apparatus 100 is coupled (e.g., the primary or the secondary command and control asset).

Upon acceptance of the transfer, control of one or more of the unmanned teamed assets may be transferred from the primary command and control asset to the secondary command and control asset. The transfer of unmanned teamed assets may be in accordance with any current or future procedure. While control of the plurality of unmanned assets is transferred from the primary unmanned teamed asset to the secondary unmanned teamed asset, the processor 106 may be configured to update the graphical user interface 400 to show symbology indicating a transfer in progress. For example, the graphical user interface 400 may include a transfer symbol 410 in-progress between the current command and control asset and the secondary command and control asset. The transfer symbol 410 may include the symbol 218 with a unidirectional or bidirectional arrow connecting to the symbol 226.

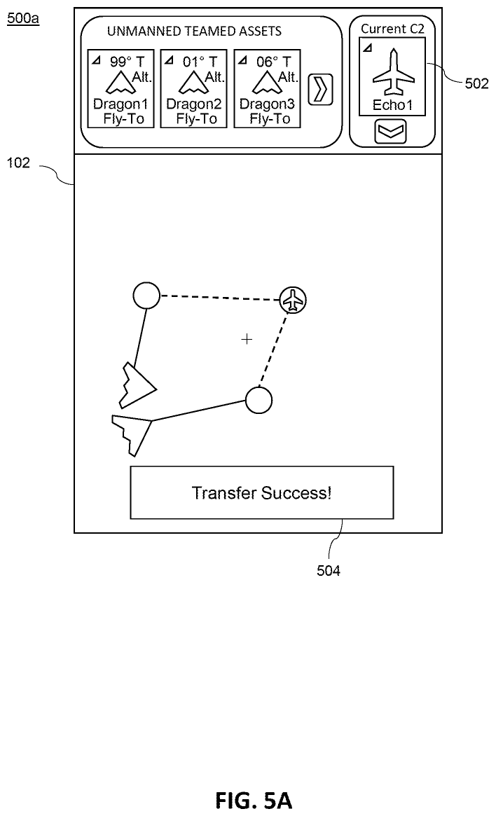

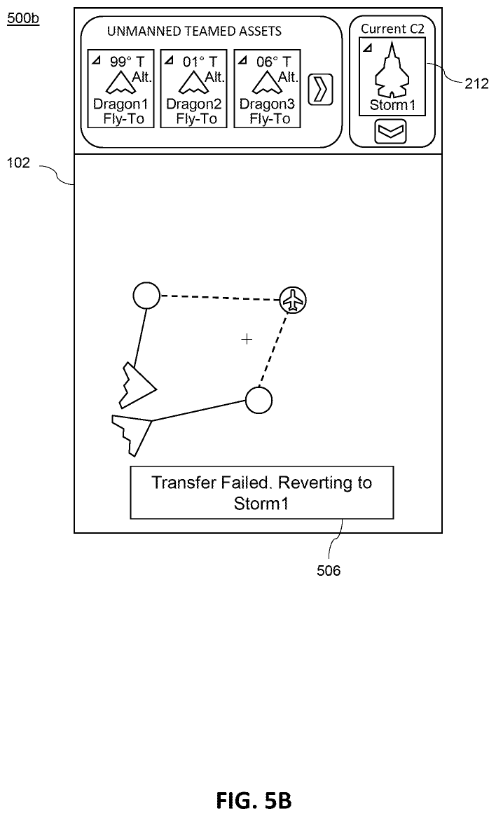

Referring now to FIG. 5A, a graphical user interface 500a displayed by the touchscreen display 102 is described, in accordance with one or more embodiments of the present disclosure. In embodiments, the processor 106 is configured to receive, by the communication interface 104, an asset transfer confirmation from the command and control asset to which the communication interface 104 is coupled (e.g., the primary or secondary command and control asset). In response to receiving the asset transfer confirmation, the processor may be configured to update the graphical user interface 500a to indicate the asset transfer confirmation. The graphical user interface 500a may indicate the asset transfer confirmation by changing the primary card 212 to the primary card 502. For example, the secondary card 214 may be updated to the primary card 502 by replacing a position of the primary card 212, and changing the indicator 224. The graphical user interface 500a may also indicate the asset transfer confirmation by an asset transfer success dialog box 504.

Referring now to FIG. 5B, a graphical user interface 500b displayed by the touchscreen display 102 is described, in accordance with one or more embodiments of the present disclosure. In embodiments, the asset transfer of the unmanned teamed assets from the primary command and control asset to the secondary command and control asset may fail. The processor 106 may be configured to receive an asset transfer failure from the command and control asset to which the computer apparatus is coupled (e.g., the secondary or primary command and control asset) by way of the communication interface 104. In response to the asset transfer failure, the processor 106 may be configured to update the graphical user interface to indicate the asset transfer failure. For example, the graphical user interface 500b may be updated with asset transfer failure dialog box 506.

What is claimed:

1. A computer apparatus comprising:
at least one processor;
a communication interface coupled with the processor, the communication interface configured to couple with a primary command and control asset, wherein the communication interface is configured to receive information regarding a plurality of unmanned teamed assets from the primary command and control asset and transmit the information to the at least one processor;
a touchscreen display in communication with the processor; and
a memory in communication with the processor, the memory storing processor executable code for configuring the at least one processor to:
generate a graphical user interface for the touchscreen display, the graphical user interface including symbology associated with each of the plurality of unmanned teamed assets based on the information received from the primary command and control asset, the graphical user interface further including symbology associated with the primary command and control asset and at least one secondary command and control asset;
receive, by the touchscreen display, a user input of an asset transfer request of the unmanned teamed assets from the primary command and control asset to the secondary command and control asset;
communicate, by the communication interface, the asset transfer request to the primary command and control asset;
receive, by the communication interface, an asset transfer confirmation from the primary command and control asset; and
update the graphical user interface to indicate the asset transfer confirmation.

2. The computer apparatus of claim 1, wherein the symbology associated with the primary command and control asset comprises a primary card and the symbology associated with the secondary command and control asset comprises a secondary card, wherein the user input of the asset transfer request is a selection of the secondary card.

3. The computer apparatus of claim 1, wherein the information regarding the plurality of unmanned teamed assets comprises at least position information and orientation information, wherein the symbology associated with each of the plurality of unmanned teamed assets comprises map symbology indicative of the position information and orientation information.

4. The computer apparatus of claim 1, wherein the symbology associated with the at least one secondary command and control asset is displayed in response to receiving a user input requesting a display of the at least one secondary command and control asset.

5. The computer apparatus of claim 1, wherein the processor is further configured to:
receive, by the communication interface, an additional asset transfer request from the primary command and control asset;
generate an asset transfer confirmation dialog on the touchscreen display;
receive, by the touchscreen display, a user input confirming a transfer of control of the unmanned teamed assets from the primary command and control asset to the secondary command and control asset; and
communicate, by the communication interface, the asset transfer confirmation to the primary command and control asset.

6. The computer apparatus of claim 5, wherein the additional transfer request is originated from the secondary command and control asset.

7. The computer apparatus of claim 1, wherein while control of the plurality of unmanned assets is transferred from the primary command and control asset to the secondary command and control asset, the processor is configured to update the graphical user interface with symbology indicating a transfer in progress.

8. The computer apparatus of claim 1, wherein the processor is further configured to:
receive, by the communication interface, a signal indicative of an asset transfer failure from the primary command and control asset; and
update the graphical user interface to indicate the asset transfer failure.

9. A computer apparatus comprising:
at least one processor;
a communication interface coupled with the processor, the communication interface configured to couple with a secondary command and control asset, wherein the communication interface is configured to receive information regarding a plurality of unmanned teamed assets from the secondary command and control asset and transmit the information to the at least one processor;
a touchscreen display in communication with the processor; and
a memory in communication with the processor, the memory storing processor executable code for configuring the at least one processor to:
generate a graphical user interface for the touchscreen display, the graphical user interface including symbology associated with each of the plurality of unmanned teamed assets based on the information received from the secondary command and control asset, the graphical user interface further including symbology associated with the secondary command and control asset and a primary command and control asset;
receive, by the communication interface an asset transfer request from the secondary command and control asset;
generate an asset transfer confirmation dialog on the touchscreen display;
receive, by the touchscreen display, a user input confirming a transfer of control of the unmanned teamed assets from the primary command and control asset to the secondary command and control asset;
communicate, by the communication interface, the user input to the secondary command and control asset;
receive, by the communication interface, an asset transfer confirmation from the secondary command and control asset; and
update the graphical user interface to indicate the asset transfer confirmation.

10. The computer apparatus of claim 9, wherein the symbology associated with the primary command and control asset comprises a primary card and the symbology associated with the secondary command and control asset comprises a secondary card, wherein the user input is a selection of the secondary card.

11. The computer apparatus of claim 9, wherein the information regarding the plurality of unmanned teamed assets comprises at least position information and orientation information, wherein the symbology associated with each of the plurality of unmanned teamed assets comprises map symbology indicative of the position information and orientation information.

12. The computer apparatus of claim 9, wherein the symbology associated with the secondary command and control asset is displayed in response to receiving a user input requesting a display of the secondary command and control asset.

13. The computer apparatus of claim 9, wherein the processor is further configured to:
receive, by the touchscreen display, a user input of an additional asset transfer request of the unmanned teamed assets from the primary command and control asset to the secondary command and control asset; and
communicate, by the communication interface, the additional asset transfer request to the secondary command and control asset.

14. The computer apparatus of claim 9, wherein while control of the plurality of unmanned assets is transferred from the primary command and control asset to the secondary command and control asset, the processor is configured to update the graphical user interface with symbology indicating a transfer in progress.

15. The computer apparatus of claim 9, wherein the processor is further configured to:
receive, by the communication interface, a signal indicative of an asset transfer failure from the secondary command and control asset; and
update the graphical user interface to indicate the asset transfer failure.
